(19) United States
(12) Patent Application Publication
(10) Pub. No.: US 2010/0223058 A1
(43) Pub. Date: Sep. 2, 2010

(54) SPEECH SYNTHESIS DEVICE, SPEECH SYNTHESIS METHOD, AND SPEECH SYNTHESIS PROGRAM

(76) Inventors: Yasuyuki Mitsui, Tokyo (JP); Reishi Kondo, Tokyo (JP)

Correspondence Address: Mr. Jackson Chen, 6535 N. STATE HWY 161, IRVING, TX, 75039, US

(21) Appl. No.: 12/681,403

(22) PCT Filed: Aug. 28, 2008
(86) PCT No.: PCT/JP2008/065381

§ 371 Date: Apr. 2, 2010

(30) Foreign Application Priority Data
Oct. 5, 2007 (JP) 2007-261704

(51) Int. Cl. G10L 13/08; G10L 13/06

(52) U.S. Cl. 704/260; 704/268; 704/E13.008; 704/E13.009

(57) ABSTRACT

A speech synthesis device includes a pitch pattern generation unit (104) which generates a pitch pattern by combining, based on pitch pattern target data including phonemic information formed from at least syllables, phonemes, and words, a standard pattern which approximately expresses the rough shape of the pitch pattern and an original utterance pattern which expresses the pitch pattern of a recorded speech, a unit waveform selection unit (106) which selects unit waveform data based on the generated pitch pattern and upon selection, selects original utterance unit waveform data corresponding to the original utterance pattern in a section where the original utterance pattern is used, and a speech waveform generation unit (107) which generates a synthetic speech by editing the selected unit waveform data so as to reproduce prosody represented by the generated pitch pattern.

### TECHNICAL FIELD

The present invention relates to a speech synthesis device, speech synthesis method, and speech synthesis program which generate prosody based on pitch pattern target data and generate a synthetic speech to reproduce the generated prosody.

### BACKGROUND ART

In the text-to-speech synthesis technology, prosodic control is known to largely influence the naturalness of a synthetic sound. To generate a natural synthetic sound similar to a human voice as much as possible, prosodic control and, more particularly, a pitch pattern generation method has been disclosed. For example, Japanese Patent Laid-Open No. 2005-292708 discloses a method of generating a pitch pattern candidate first and replacing part of the pitch pattern candidate with an alternate pattern, thereby generating a pitch pattern and synthesizing a speech.

In addition, Japanese Patent Laid-Open No. 2001-249678 discloses a technique of generating a synthetic speech using intonation data in a database, which coincides with all or part of an input text.

Japanese Patent No. 3235747 discloses a technique of generating a synthetic speech by using speech waveform data corresponding to each 1-pitch period obtained by actual speech analysis for a voiced sound portion with periodicity and directly using the actual speech as speech waveform data for a voiceless sound portion without periodicity. The techniques disclosed in Japanese Patent Laid-Open Nos. 2005-292708 and 2001-249678 and Japanese Patent No. 3235747 will be referred to as a first related example hereinafter.

In the text-to-speech synthesis technology and, more particularly, a speech synthesis technique using a waveform editing scheme, prosody is generated, and unit waveforms are edited to reproduce the prosody, thereby constructing the entire waveform. At this time, since the pitch frequency changes from that of the recorded speech, the quality of the generated synthetic sound is known to become poorer. To prevent this sound quality degradation, a method is disclosed in a reference “Nick Campbell and Alan Black, ‘CHATR: A multi-lingual speech re-sequencing synthesis system’, Technical Report of the Research Institute of Signal Processing, vol. 96, no. 39, pp. 45-52, 1996”, which connects waveforms without changing their pitch frequency information, thereby generating a high-quality synthetic sound, like, for example, a speech synthesis scheme called CHATR. The method disclosed in this reference will be referred to as a second related example hereinafter.

### DISCLOSURE OF INVENTION

### Problems to be Solved by the Invention

In the first related example, the sound quality degradation of the waveform is not taken into consideration at all. Hence, the sound quality degrades when reproducing the generated prosody.

In the second related example, since the recorded waveforms are directly connected, the sound quality is very high. However, it is impossible to reproduce desired prosody because the pitch pattern shape is not changed. This greatly decreases the stability of prosody of the generated synthetic sound.

The present invention has been made in order to solve the above-described problems, and has as its exemplary object to provide a speech synthesis device, speech synthesis method, and speech synthesis program capable of generating a synthetic speech which maintains the naturalness and stability of prosody and ensures high sound quality.

### Means of Solution to the Problem

A speech synthesis device according to an exemplary aspect of the invention includes pitch pattern generation means for generating a pitch pattern by combining, based on pitch pattern target data including phonemic information formed from at least syllables, phonemes, and words, a standard pattern which approximately expresses a rough shape of the pitch pattern and an original utterance pattern which expresses a pitch pattern of a recorded speech, unit waveform selection means for selecting unit waveform data based on the generated pitch pattern and upon selection, selecting original utterance unit waveform data corresponding to the original utterance pattern in a section where the original utterance pattern is used; and speech waveform generation means for generating a synthetic speech by editing the selected unit waveform data so as to reproduce prosody represented by the generated pitch pattern.

A speech synthesis method according to another exemplary aspect of the invention includes the pitch pattern generation step of generating a pitch pattern in combining, based on pitch pattern target data including phonemic information formed from at least syllables, phonemes, and words, a standard pattern which approximately expresses a rough shape of the pitch pattern and an original utterance pattern which expresses a pitch pattern of a recorded speech, the unit waveform selection step of selecting unit waveform data based on the generated pitch pattern and upon selection, selecting original utterance unit waveform data corresponding to the original utterance pattern in a section where the original utterance pattern is used, and the speech waveform generation step of generating a synthetic speech by editing the selected unit waveform data so as to reproduce prosody represented by the generated pitch pattern.

A speech synthesis program according to still another exemplary aspect of the invention causes a computer to execute the pitch pattern generation step of generating a pitch pattern in combining, based on pitch pattern target data including phonemic information formed from at least syllables, phonemes, and words, a standard pattern which approximately expresses a rough shape of the pitch pattern and an original utterance pattern which expresses a pitch pattern of a recorded speech, the unit waveform selection step of selecting unit waveform data based on the generated pitch pattern and upon selection, selecting original utterance unit waveform data corresponding to the original utterance pattern in a section where the original utterance pattern is used, and the speech waveform generation step of generating a synthetic speech by editing the selected unit waveform data so as to reproduce prosody represented by the generated pitch pattern.

### EFFECT OF THE INVENTION

According to the present invention, a pitch pattern is generated by combining a standard pattern and an original utterance pattern. For an original utterance pattern portion, corresponding original utterance unit waveform data is used to faithfully reproduce the pitch pattern of a recorded speech. This makes it possible to generate a synthetic speech which maintains the naturalness and stability of prosody of each accent phrase and the whole sentence and ensures high sound quality.

### BRIEF DESCRIPTION OF DRAWINGS

FIG. 1 is a block diagram showing the arrangement of a speech synthesis device according to the first exemplary embodiment of the present invention;

FIG. 2 is a flowchart illustrating the operation of the speech synthesis device according to the first exemplary embodiment of the present invention;

FIG. 3 is a block diagram showing the arrangement of a speech synthesis device according to the second exemplary embodiment of the present invention;

FIG. 4 is a block diagram showing the arrangement of a speech synthesis device according to the third exemplary embodiment of the present invention;

FIG. 5 is a block diagram showing the schematic arrangement of a speech synthesis device according to the fourth exemplary embodiment of the present invention;

FIG. 6 is a block diagram showing an example of the arrangement of a pitch pattern generation unit according to the fourth exemplary embodiment of the present invention;

FIG. 7 is a flowchart illustrating the operation of the pitch pattern generation unit according to the fourth exemplary embodiment of the present invention;

FIG. 8 is a graph showing an example of connection of standard patterns and an original utterance pattern according to the fourth exemplary embodiment of the present invention;

FIG. 9 is a graph showing the node positions of a pitch pattern according to the fourth exemplary embodiment of the present invention;

FIG. 10 is a block diagram showing an example of the arrangement of a pitch pattern generation unit according to the fifth exemplary embodiment of the present invention; and

FIG. 11 is a flowchart illustrating the operation of the pitch pattern generation unit according to the fifth exemplary embodiment of the present invention.

### BEST MODE FOR CARRYING OUT THE INVENTION

### First Exemplary Embodiment

The best mode for carrying out the present invention will now be described with reference to the accompanying drawings. Note that the same reference numerals denote the same constituent elements throughout the drawings, and a description thereof will appropriately be omitted.

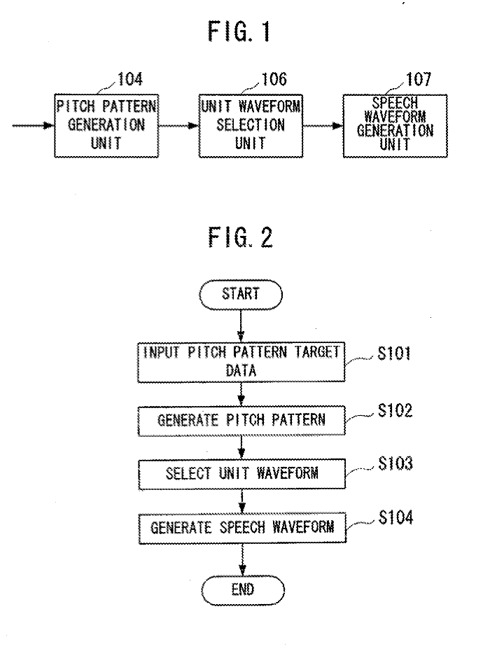

FIG. 1 is a block diagram showing the arrangement of a speech synthesis device according to the first exemplary embodiment of the present invention. FIG. 2 is a flowchart illustrating the operation of the speech synthesis device in FIG. 1.

Referring to FIG. 1, the speech synthesis device according to the exemplary embodiment includes a pitch pattern generation unit 104, unit waveform selection unit 106, and speech waveform generation unit 107.

The operation of this exemplary embodiment will be described below with reference to FIGS. 1 and 2.

Upon receiving pitch pattern target data that is information necessary for pitch pattern generation (step S101 in FIG. 2), the pitch pattern generation unit 104 generates a pitch pattern by combining a standard pattern prepared in advance with an original utterance pattern based on the pitch pattern target data (step S102). The pitch pattern target data includes phonemic information formed from at least syllables, phonemes, and words. The standard pattern approximately expresses the rough shape of at least one pitch pattern of a speech. The original utterance pattern faithfully reproduces the pitch pattern of a recorded speech.

The unit waveform selection unit 106 selects unit waveform data based on the pitch pattern generated by the pitch pattern generation unit 104 (step S103). At this time, for a portion formed from the original utterance pattern in the pitch pattern generated by the pitch pattern generation unit 104, the unit waveform selection unit 106 selects corresponding original utterance unit waveform data, thereby faithfully reproducing the pitch pattern of the recorded speech. For a portion formed from the standard pattern, any unit waveform is usable. The unit waveform data is generated from the recorded speech in advance. A unit waveform indicates a speech waveform serving as the minimum unit of a synthetic sound.

The speech waveform generation unit 107 generates speech waveform data based on the pitch pattern generated by the pitch pattern generation unit 104 and the unit waveform data selected by the unit waveform selection unit 106 (step S104). The speech waveform generation is done by arranging unit waveforms and superimposing them based on the pitch pattern.

According to this exemplary embodiment, a pitch pattern is generated by combining a standard pattern and an original utterance pattern, and a corresponding unit waveform is used for the original utterance pattern portion, thereby faithfully reproducing the pitch pattern of the recorded speech. This allows to generate a synthetic sound with high stability and naturalness.

### Second Exemplary Embodiment

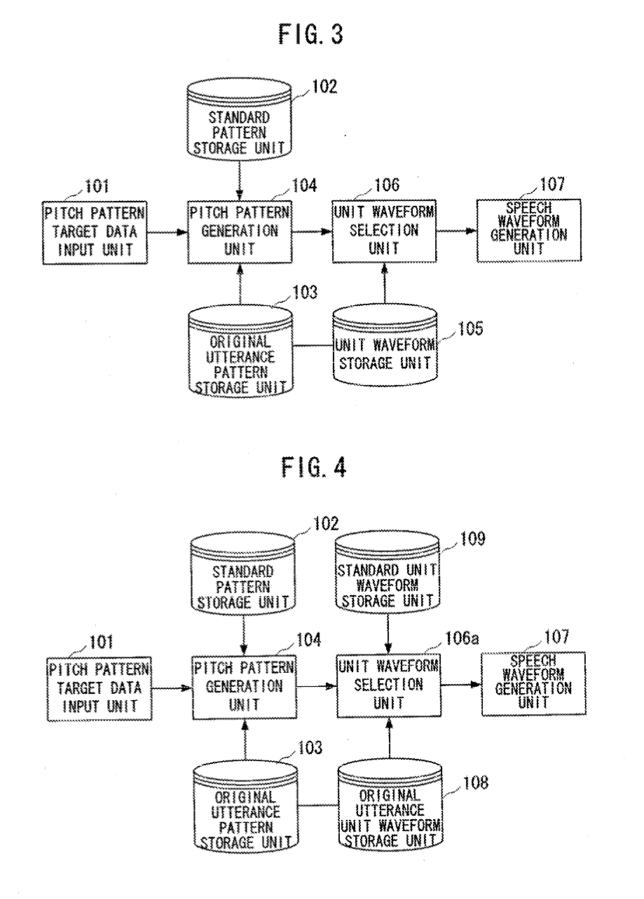

The second exemplary embodiment of the present invention will be described next. FIG. 3 is a block diagram showing the arrangement of a speech synthesis device according to the second exemplary embodiment of the present invention. In this exemplary embodiment, the first exemplary embodiment will be explained in more detail.

Referring to FIG. 3, the speech synthesis device according to the exemplary embodiment includes a pitch pattern target data input unit 101, standard pattern storage unit 102, original utterance pattern storage unit 103, pitch pattern generation unit 104, unit waveform storage unit 105, unit waveform selection unit 106, and speech waveform generation unit 107.

The overall operation of the speech synthesis device according to this exemplary embodiment is the same as in the first exemplary embodiment. Hence, the operation of this exemplary embodiment will be described with reference to FIGS. 2 and 3.

The standard pattern storage unit 102 stores, in advance, standard patterns each of which approximately expresses the rough shape of at least one pitch pattern of a speech.

The original utterance pattern storage unit 103 stores, in advance, original utterance patterns each of which faithfully reproduces the pitch pattern of a recorded speech.

The unit waveform storage unit 105 stores, in advance, unit waveform data generated from the recorded speech. The unit waveform includes at least an original utterance unit waveform corresponding to the original utterance pattern.

The pitch pattern target data input unit 101 inputs, to the pitch pattern generation unit 104, pitch pattern target data that is information necessary for pitch pattern generation (step S101 in FIG. 2).

The pitch pattern generation unit 104 generates a pitch pattern by combining the standard pattern stored in the standard pattern storage unit 102 with the original utterance pattern stored in the original utterance pattern storage unit 103 based on the pitch pattern target data (step S102).

The unit waveform selection unit 106 selects unit waveform data stored in the original utterance pattern storage unit 103, based on the pitch pattern generated by the pitch pattern generation unit 104 (step S103).

The speech waveform generation unit 107 generates speech waveform data based on the pitch pattern generated by the pitch pattern generation unit 104 and the unit waveform data selected by the unit waveform selection unit 106 (step S104).

According to this exemplary embodiment, it is possible to obtain the same effect as in the first exemplary embodiment.

### Third Exemplary Embodiment

The third exemplary embodiment of the present invention will be described next with reference to the accompanying drawings. FIG. 4 is a block diagram showing the arrangement of a speech synthesis device according to the third exemplary embodiment of the present invention.

Referring to FIG. 4, the speech synthesis device according to this exemplary embodiment includes a standard unit waveform storage unit 109 in addition to the arrangement of the second exemplary embodiment, an original utterance unit waveform storage unit 108 in place of the unit waveform storage unit 105, and a unit waveform selection unit 106a in place of the unit waveform selection unit 106.

The overall operation of the speech synthesis device according to this exemplary embodiment is the same as in the first exemplary embodiment. Hence, the operation of this exemplary embodiment will be described with reference to FIGS. 2 and 4.

The original utterance unit waveform storage unit 108 stores, in advance, original utterance unit waveform data corresponding to original utterance patterns.

The standard unit waveform storage unit 109 stores, in advance, standard unit waveform data corresponding to standard patterns.

The operations of a pitch pattern target data input unit 101 and a pitch pattern generation unit 104 are the same as in the first exemplary embodiment (steps S101 and S102).

The unit waveform selection unit 106a selects unit waveform data stored in the standard unit waveform storage unit 109 based on the pitch pattern generated by the pitch pattern generation unit 104 step S103). At this time, for a portion formed from the original utterance pattern in the pitch pattern generated by the pitch pattern generation unit 104, the unit waveform selection unit 106a selects corresponding original utterance unit waveform data stored in the original utterance unit waveform storage unit 108, thereby faithfully reproducing the pitch pattern of the recorded speech. For a portion formed from the standard pattern in the generated pitch pattern, the unit waveform selection unit 106a selects standard unit waveform data stored in the standard unit waveform storage unit 109.

The operation of a speech waveform generation unit 107 is the same as in the first exemplary embodiment (step S104). According to this exemplary embodiment, the units to be used for the original utterance pattern portion and the standard pattern portion can be discriminated. It is therefore possible to select a more optimum unit for each pattern.

### Fourth Exemplary Embodiment

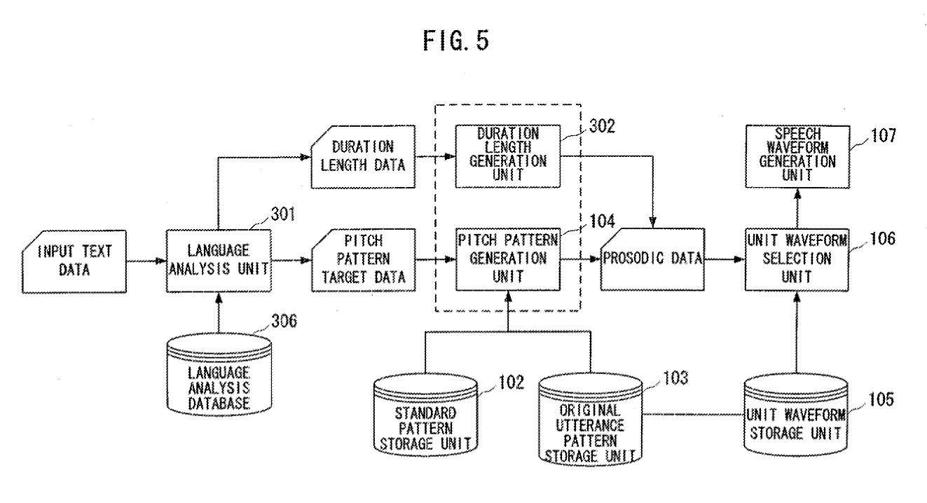

The fourth exemplary embodiment of the present invention will be described next. FIG. 5 is a block diagram showing the schematic arrangement of a speech synthesis device according to the fourth exemplary embodiment of the present invention. In this exemplary embodiment, a more detailed example of the second exemplary embodiment will be explained.

A language analysis unit 301 analyzes input text data using a language analysis database 306, and generates pitch pattern target data and duration length data for each accent phrase. The language analysis is done using an existing morpheme analysis method.

The pitch pattern target data includes at least phonemic information formed from syllable strings, phonemes, and words. The pitch pattern target data may include information such as pause positions, number of moras, accent types, accent phrase delimiters, and accent phrase positions in a text.

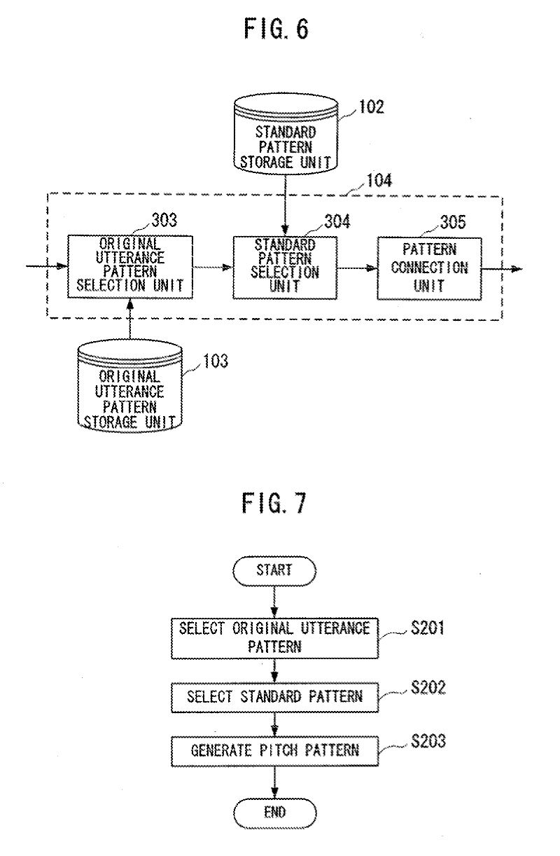

FIG. 6 shows a detailed example of the arrangement of a pitch pattern generation unit 104 according to the exemplary embodiment. FIG. 7 illustrates the operation of the pitch pattern generation unit 104. The pitch pattern generation unit 104 includes an original utterance pattern selection unit 303, standard pattern selection unit 304, and pattern connection unit 305.

The original utterance pattern selection unit 303 selects an original utterance pattern to be used in a pitch pattern based on pitch pattern target data and phonemic information, accent positions, and the like stored in an original utterance pattern storage unit 103 (step S201 in FIG. 7).

A method of causing the original utterance pattern selection unit 303 to select an original utterance pattern will be described using a detailed example.

The original utterance pattern storage unit 103 stores original utterance patterns and syllable string data representing uttered contents. Each original utterance pattern faithfully reproduces a pitch pattern including a slight change of the pitch frequency of a recorded speech, and is expressed by nodes having time information and pitch frequency values. The original utterance pattern storage unit 103 is assumed to store an original utterance pattern which expresses the recorded speech of uttered contents [kadoushiteinakereba (kadoushiteina″kereba)]. [″] represents the accent position in the standard language.

The original utterance pattern selection unit 303 searches for an original utterance pattern based on the syllable string information stored in the original utterance pattern storage unit 103, and selects an original utterance pattern which coincides with the pitch pattern target data. For example, if text data [sadoushiteinakatta] is input, the syllable string represented by the pitch pattern target data is [sadoushiteina″katta]. The original utterance pattern selection unit 303 searches the original utterance pattern data in the original utterance pattern storage unit 103 for a portion having a syllable string and accent position which coincide with those of the pitch pattern target data.

In the above-described example, both the syllable string and the accent position coincide in the portion [doushiteina″] of [kadoushiteina″kereba]. Hence, that portion obtained as the search result is usable as the original utterance pattern. In this way, the original utterance pattern in the accent phrase is selected. Note that when the section of the accent phrase where the original utterance pattern is used is decided, standard patterns are used in the remaining sections of the accent phrase. Hence, the sections where the standard patterns are used are also decided simultaneously.

A standard pattern storage unit 102 stores standard patterns. Each standard pattern includes nodes in number much smaller than in an original utterance pattern and expresses a standard pitch pattern that does not depend on a syllable string. The standard pattern is expressed by nodes having time information and pitch frequency values, like the original utterance pattern.

The standard pattern selection unit 304 selects, from the standard patterns stored in the standard pattern storage unit 102, a standard pattern to be used in the standard pattern section decided by the original utterance pattern selection unit 303 (step S202). The standard pattern selection unit 304 selects a coincident standard pattern based on the number of moras and accent type of the accent phrase included in the pitch pattern target data.

The pattern connection unit 305 connects the original utterance pattern selected by the original utterance pattern selection unit 303 to the standard pattern selected by the standard pattern selection unit 304, thereby generating the pitch pattern of the accent phrase (step S203). The original utterance pattern and the standard pattern are smoothly connected by deforming the standard pattern.

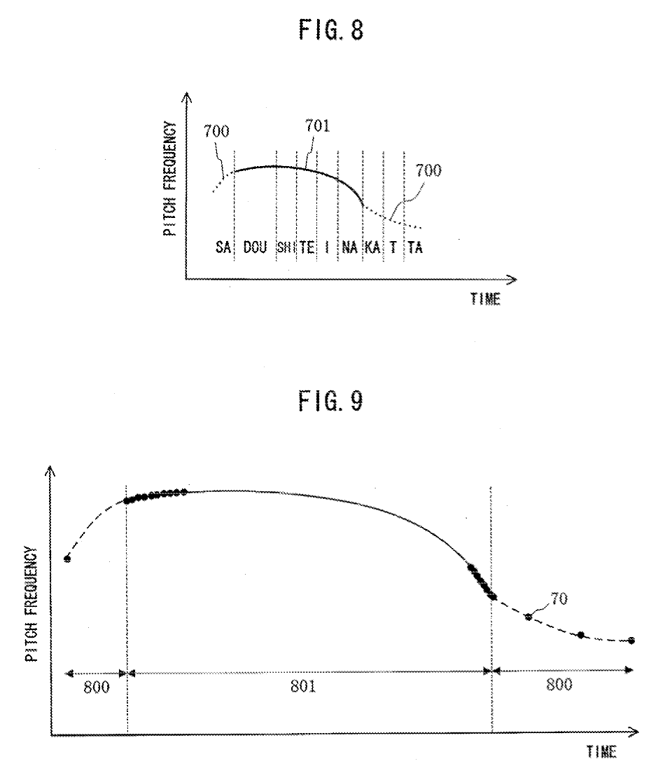

FIG. 8 shows an example of connection of standard patterns and an original utterance pattern for the above-described example [sadoushiteinakatta]. Referring to FIG. 8, reference numeral 700 denotes a standard pattern; and 701, an original utterance pattern. As shown in FIG. 8, [sa] at the start and [katta] at the end correspond to standard pattern sections. [Doushiteina] corresponds to an original utterance pattern section. The standard patterns and the original utterance pattern are smoothly connected at the endpoints. To connect the standard patterns and the original utterance pattern, the standard patterns are translated in the direction of pitch frequency axis so that the endpoint pitch frequencies of the standard patterns coincide with the endpoint pitch frequencies of the original utterance pattern to be connected to them.

FIG. 9 is a graph showing the node positions of a pitch pattern. Dots 70 arranged on the pitch pattern shown in FIG. 9 represent nodes that express the pitch pattern. Reference numeral 800 denotes a standard pattern section 800; and 801, an original utterance pattern section. Referring to FIG. 9, the nodes are coarse in the standard pattern sections, whereas the nodes are arranged very densely in the original utterance pattern section. It is therefore necessary to interpolate the pitch pattern between the nodes in the standard pattern section. In the original utterance pattern section, however, the recorded speech is reproduced without interpolation. The pattern connection unit 305 can interpolate the standard pattern using, e.g., a spline function.

A duration length generation unit 302 generates the duration length of the syllable string based on the duration length data generated by the language analysis unit 301.

A unit waveform selection unit 106 selects unit waveform data stored in a unit waveform storage unit 105 based on prosodic data including the duration length data generated by the duration length generation unit 302 and the pitch pattern generated by the pitch pattern generation unit 104. For the original utterance pattern section in the pitch pattern, the unit waveform selection unit 106 selects corresponding unit waveform data. Hence, when selecting a unit, the unit in the standard pattern section is selected in consideration of connection to the unit waveform in the original utterance pattern section.

A speech waveform generation unit 107 generates a synthetic sound by editing the unit waveform data selected by the unit waveform selection unit 106 so that the generated prosody is reproduced.

When this exemplary embodiment is used, a corresponding original utterance unit waveform is used in the original utterance pattern section so as to reproduce the recorded speech. Standard patterns are used in the remaining sections not to impair the rough shape of the pitch pattern. This enables to generate a stable pitch pattern and a synthetic sound having high naturalness and sound quality equivalent to those of a recorded speech.

In this exemplary embodiment, the original utterance pattern storage unit 103 stores the syllable string information of the original utterance pattern. However, the syllable string information may be stored in the unit waveform storage unit 105 or another database (unit waveform syllable string information storage unit) (not shown) corresponding to the original utterance pattern storage unit 103. When the syllable string information of the original utterance pattern is stored in a storage unit other than the original utterance pattern storage unit 103, the original utterance pattern selection unit 303 decides the syllable string by referring to the unit waveform storage unit 105 or the unit waveform syllable string information storage unit.

In this exemplary embodiment, the standard patterns and the original utterance pattern are delimited using syllables as the minimum units. Instead, the patterns may be delimited using phonemes or half-phonemes as the minimum units. Using finer units such as half-phonemes enables to more flexibly set the connection points between the original utterance pattern section and the standard pattern sections.

Delimiters between the standard patterns and the original utterance pattern need not coincide with the minimum units stored in the unit waveform storage unit 105. For example, the unit waveform storage unit 105 may store unit waveforms based on half-phonemes serving as the minimum units, and switching from the original utterance pattern to the standard pattern may be done using syllables as the minimum units.

In this exemplary embodiment, the standard patterns are smoothly connected to the original utterance pattern by deforming the standard patterns (translating the standard patterns in the direction of pitch frequency axis). However, the original utterance pattern may be deformed. Even when the standard patterns and the original utterance pattern cannot be connected smoothly only by deforming the standard patterns, deforming the original utterance pattern can cope with this.

In this exemplary embodiment, the standard pattern storage unit 102 is provided to store each standard pattern using time information and pitch frequency values. However, instead of providing the standard pattern storage unit 102, a standard pattern may be generated using a model such as an F0 generation model (Fujisaki model).

### Fifth Exemplary Embodiment

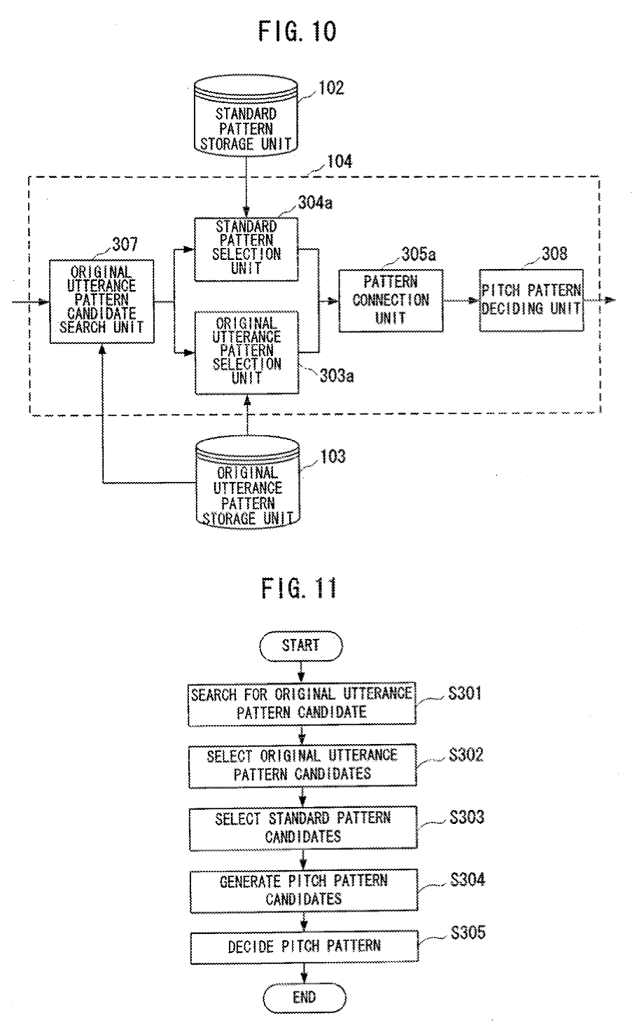

The fifth exemplary embodiment of the present invention will be described next. The overall arrangement of a speech synthesis device according to this exemplary embodiment is the same as in the fourth embodiment except only the arrangement and operation of a pitch pattern generation unit 104. Hence, only a detailed example of the arrangement of the pitch pattern generation unit 104 will be explained with reference to FIG. 10.

The pitch pattern generation unit 104 of this exemplary embodiment includes an original utterance pattern selection unit 303a, standard pattern selection unit 304a, pattern connection unit 305a, original utterance pattern candidate search unit 307, and pitch pattern deciding unit 308. FIG. 11 illustrates the operation of the pitch pattern generation unit 104 of the exemplary embodiment.

Based on pitch pattern target data and syllable string information stored in an original utterance pattern storage unit 103, the original utterance pattern candidate search unit 307 searches for original utterance pattern candidates that coincide with the pitch pattern target data (step S301 in FIG. 11). if the original utterance pattern storage unit 103 stores a plurality of original utterance patterns concerned, the original utterance pattern candidate search unit 307 outputs all candidates concerned to the standard pattern selection unit 304a and the original utterance pattern selection unit 303a. In this exemplary embodiment, assume that a plurality of original utterance patterns are found as candidates.

The original utterance pattern selection unit 303a selects, as original utterance pattern candidates, all the original utterance patterns found by the original utterance pattern candidate search unit 307 (step S302). When the original utterance pattern selection unit 303a decides the section where an original utterance pattern is used, sections where standard patterns are used are also decided simultaneously, as described in the fourth exemplary embodiment.

The standard pattern selection unit 304a selects the candidates of standard patterns to be used in the standard pattern sections decided by the original utterance pattern selection unit 303a from the standard patterns stored in a standard pattern storage unit 102 (step S303). The operation of the standard pattern selection unit 304a is the same as that of the standard pattern selection unit 304 of the fourth exemplary embodiment. The standard pattern selection unit 304a performs the standard pattern candidate selection for each of the original utterance pattern candidates selected by the original utterance pattern selection unit 303a.

The pattern connection unit 305a connects the original utterance pattern candidates selected by the original utterance pattern selection unit 303a to the standard pattern candidates selected by the standard pattern selection unit 304a, thereby generating pitch pattern candidates (step S304). The operation of the pattern connection unit 305a is the same as that of the pattern connection unit 305 of the fourth embodiment. In this case, however, the original utterance patterns and the standard patterns are connected by deforming the original utterance patterns (translating the original utterance patterns in the direction of pitch frequency axis). The pattern connection unit 305a performs the pitch pattern candidate generation for each of the combinations of the original utterance pattern candidates and corresponding to standard pattern candidates.

Based on a preset selection criterion, the pitch pattern deciding unit 308 decides an optimum pitch pattern from the plurality of pitch pattern candidates generated by the pattern connection unit 305a (step S305). The optimum pitch pattern selection criterion will be described in detail. From the viewpoint of pitch pattern generation, the pitch frequency of the original utterance pattern needs to be changed to smoothly connect the standard patterns to the original utterance pattern and generate a target pitch pattern. However, as is widely known, when waveforms are edited by changing the pitch frequency of a unit waveform, the sound quality of the edited waveforms degrades. Hence, from the viewpoint of sound quality, the change amount of the pitch frequency in the original utterance pattern section should be made as small as possible. To do this, “a pitch pattern candidate which minimizes the pitch frequency change amount in the original utterance pattern section is selected as the optimum pitch pattern” is used as the criterion to select the optimum pitch pattern from the plurality of pitch pattern candidates.

If a plurality of original utterance patterns that satisfy the condition exist in the original utterance pattern storage unit 103, a pitch pattern using an original utterance pattern with a minimum pitch frequency change amount is selected from them using the exemplary embodiment. This enables to generate a synthetic sound having higher naturalness and sound quality.

In this exemplary embodiment, after the pattern connection unit 305a has actually generated a plurality of pitch patterns, the pitch pattern deciding unit 308 decides one pitch pattern. However, the pitch patterns need not always be generated actually. For example, only the pitch frequency change amount at an endpoint of the original utterance pattern may be calculated, and a pitch pattern with a minimum change amount may be selected.

In this exemplary embodiment, the original utterance pattern candidate search unit 307 may limit the number of original utterance pattern candidates. As the limiting method, an original utterance pattern candidate with a short syllable string may be excluded. Alternatively, the target pitch frequency may be calculated, and an original utterance pattern candidate having a large difference value to the target pitch frequency may be excluded. This allows to reduce the calculation load.

As the optimum pitch pattern selection criterion, “a pitch pattern candidate in which the shape of the generated pitch pattern of the accent phrase is similar to the shape of the standard pattern of the accent phrase is more appropriate” may be added. Use of this criterion makes it possible to prevent the rough shape of the generated pitch pattern from largely deviating from the standard pitch pattern. The similarity of the pattern shape may be determined using information simply representing the pattern shape, for example, a rough shape expressed by pitch frequencies and time information at three points, i.e., start point, peak point, and end point. Using the simpler rough shape for the selection criterion enables to reduce the calculation load.

Note that in the first to fifth exemplary embodiments, the pitch pattern generation unit 104 may first select the standard pattern of the accent phrase and then replace part of the standard pattern with the original utterance pattern.

The speech synthesis device explained in each of the first to fifth exemplary embodiments can be implemented by a program which controls a computer including a CPU, storage device, and interface, and these hardware resources. The CPU of the computer executes the processing described in the first to fifth exemplary embodiments in accordance with the program stored in the storage device.

The present invention has been described above with reference to the exemplary embodiments. However, the present invention is not limited to the exemplary embodiments. The arrangement and details of the present invention can also be implemented by appropriately combining the above exemplary embodiments, or can be changed as needed within the range of the claims of the present invention.

This application is based upon and claims the benefit of priority from Japanese patent application No. 2007-261704, filed on Oct. 5, 2007, the disclosure of which is incorporated herein in its entirety by reference.

### INDUSTRIAL APPLICABILITY

The present invention is applicable to a speech synthesis technique.

1. A speech synthesis device comprising:
a pitch pattern generation unit that generates pitch pattern by combining, based on pitch pattern target data including phonemic information formed from at least syllables, phonemes, and words, a standard pattern which approximately expresses a rough shape of the pitch pattern and an original utterance pattern which expresses a pitch pattern of a recorded speech;
a unit waveform selection unit that generates unit waveform data based on the generated pitch pattern and upon selection, selects original utterance unit waveform data corresponding to the original utterance pattern in a section where the original utterance pattern is used; and
a speech waveform generation unit that generates a synthetic speech by editing the selected unit waveform data so as to reproduce prosody represented by the generated pitch pattern.

2. A speech synthesis device according to claim 1, wherein said unit waveform selection unit selects unit waveform data different from the original utterance unit waveform in a section where the standard pattern is used.

3. A speech synthesis device according to claim 1, further comprising an original utterance pattern storage unit that stores the original utterance pattern and syllable string information corresponding to the original utterance pattern,
wherein said pitch pattern generation unit comprises:
an original utterance pattern selection unit that selects the original utterance pattern based on at least the pitch pattern target data and the syllable string information stored in said original utterance pattern storage unit;
a standard pattern selection unit that selects the standard pattern based on the pitch pattern target data in a section where the standard pattern is used; and
a pattern connection unit that connects the original utterance pattern selected by said original utterance pattern selection unit and the standard pattern selected by said standard pattern selection unit, thereby generating the pitch pattern.

4. A speech synthesis device according to claim 1, wherein
said pitch pattern generation unit decides an arrangement of the standard pattern and the original utterance pattern based on a feature amount of the original utterance unit waveform data, and
at least a pitch frequency is included as the feature amount of the original utterance unit waveform data.

5. A speech synthesis device according to claim 4, wherein said pitch pattern generation unit decides the arrangement of the standard pattern and the original utterance pattern so as to minimize a change amount of the feature amount of the unit waveform data in the original utterance pattern section.

6. A speech synthesis device according to claim 1, wherein said pitch pattern generation unit replaces part of the standard pattern of a whole accent phrase with the original utterance pattern.

7. A speech synthesis device according to claim 1, further comprising a language analysis unit that analyzes a language of input text data and creates the pitch pattern target data.

8. A speech synthesis device according to claim 1, further comprising an original utterance pattern storage unit that stores the original utterance pattern and syllable string information corresponding to the original utterance pattern,
wherein said pitch pattern generation unit comprises:
an original utterance pattern candidate search unit that searches for original utterance pattern candidates that coincide with the pitch pattern target data based on at least the pitch pattern target data and the syllable string information stored in said original utterance pattern storage unit;
an original utterance pattern selection unit that selects all original utterance patterns found by said original utterance pattern candidate search unit as the original utterance pattern candidates;
a standard pattern selection unit that selects standard pattern candidates based on the pitch pattern target data in a section where the standard pattern is used;
a pattern connection unit that connects the original utterance pattern candidates selected by said original utterance pattern selection unit and the standard pattern candidates selected by said standard pattern selection unit, thereby generating pitch pattern candidates; and
a pitch pattern deciding unit that decides, in accordance with a preset selection criterion, an optimum pitch pattern from the plurality of pitch pattern candidates generated by said pattern connection unit.

9. A speech synthesis method comprising:
the pitch pattern generation step of generating a pitch pattern in combining, based on pitch pattern target data including phonemic information formed from at least syllables, phonemes, and words, a standard pattern which approximately expresses a rough shape of the pitch pattern and an original utterance pattern which expresses a pitch pattern of a recorded speech;
the unit waveform selection step of selecting unit waveform data based on the generated pitch pattern and upon selection, selecting original utterance unit waveform data corresponding to the original utterance pattern in a section where the original utterance pattern is used; and
the speech waveform generation step of generating a synthetic speech by editing the selected unit waveform data so as to reproduce prosody represented by the generated pitch pattern.

10. A speech synthesis method according to claim 9, wherein in the unit waveform selection step, unit waveform data different from the original utterance unit waveform is selected in a section where the standard pattern is used.

11. A speech synthesis method according to claim 9, wherein the pitch pattern generation step comprises:
the original utterance pattern selection step of selecting the original utterance pattern based on at least the pitch pattern target data and syllable string information of the original utterance pattern stored in an original utterance pattern storage unit;
the standard pattern selection step of selecting the standard pattern based on the pitch pattern target data in a section where the standard pattern is used; and
the pattern connection step of connecting the original utterance pattern selected in the original utterance pattern selection step and the standard pattern selected in the standard pattern selection step, thereby generating the pitch pattern.

12. A speech synthesis method according to claim 9, wherein
the pitch pattern generation step comprises the step of deciding an arrangement of the standard pattern and the original utterance pattern based on a feature amount of the original utterance unit waveform data, and
at least a pitch frequency is included as the feature amount of the original utterance unit waveform data.

13. A speech synthesis method according to claim 12, wherein in the pitch pattern generation step, the arrangement of the standard pattern and the original utterance pattern is decided so as to minimize a change amount of the feature amount of the unit waveform data in the original utterance pattern section.

14. A speech synthesis method according to claim 9, wherein the pitch pattern generation step comprises the step of replacing part of the standard pattern of a whole accent phrase with the original utterance pattern.

15. A speech synthesis method according to claim 9, further comprising, before the pitch pattern generation step, the language analysis step of analyzing a language of input text data and creating the pitch pattern target data.

16. A speech synthesis method according to claim 9, wherein the pitch pattern generation step comprises:
the original utterance pattern candidate search step of searching for original utterance pattern candidates that coincide with the pitch pattern target data based on at least the pitch pattern target data and syllable string information of the original utterance pattern stored in an original utterance pattern storage unit;
the original utterance pattern selection step of selecting all original utterance patterns found in the original utterance pattern candidate search step as the original utterance pattern candidates;
the standard pattern selection step of selecting standard pattern candidates based on the pitch pattern target data in a section where the standard pattern is used;
the pattern connection step of connecting the original utterance pattern candidates selected in the original utterance pattern selection step and the standard pattern candidates selected in the standard pattern selection step, thereby generating pitch pattern candidates; and
the pitch pattern deciding step of deciding, in accordance with a preset selection criterion, an optimum pitch pattern from the plurality of pitch pattern candidates generated in the pattern connection step.

17. A computer-readable storage medium storing a speech synthesis program which causes a computer to execute:
the pitch pattern generation step of generating a pitch pattern in combining, based on pitch pattern target data including phonemic information formed from at least syllables, phonemes, and words, a standard pattern which approximately expresses a rough shape of the pitch pattern and an original utterance pattern which expresses a pitch pattern of a recorded speech;
the unit waveform selection step of selecting unit waveform data based on the generated pitch pattern and upon selection, selecting original utterance unit waveform data corresponding to the original utterance pattern in a section where the original utterance pattern is used; and
the speech waveform generation step of generating a synthetic speech by editing the selected unit waveform data so as to reproduce prosody represented by the generated pitch pattern.
